(19) United States
(12) Patent Application Publication
(10) Pub. No.: US 2009/0246554 A1
(43) Pub. Date: Oct. 1, 2009

(54) LAMINATE HAVING PEELABILITY AND PRODUCTION METHOD THEREFOR

(76) Inventors: Mikio Furukawa, Kyoto (JP); Seiji Sejima, Kyoto (JP); Yoshiaki Echigo, Kyoto (JP)

Correspondence Address: BUTZEL LONG;IP DOCKETING DEPT, 350 SOUTH MAIN STREET, SUITE 300, ANN ARBOR, MI, 48104, US

(21) Appl. No.: 12/310,219

(22) PCT Filed: May 9, 2008
(86) PCT No.: PCT/JP2008/001164

§ 371 Date: Feb. 17, 2009

(30) Foreign Application Priority Data
May 23, 2007 (JP) 2007-136969
Jun. 18, 2007 (JP) 2007-160676
Jul. 19, 2007 (JP) 2007-188783

(51) Int. Cl. B32B 15/088; B32B 15/04; B32B 37/12; B32B 15/01; B32B 15/08; B05D 5/12; C23C 28/02

(52) U.S. Cl. 428/656; 428/457; 428/332; 428/544; 428/458; 427/124; 205/186; 156/182

(57) ABSTRACT

A metal conductor layer is provided on at least one surface of a heat resistant base. The heat resistant base is peelable from the metal conductor layer. The heat resistant base is preferably a metal foil or a non-thermoplastic polyimide resin film. The metal conductor layer preferably includes a vapor deposition metal layer and/or a plating metal layer. The metal conductor layer preferably includes a metal layer (I) formed in an interface with the heat resistant base by vapor deposition, and at least one metal layer (II) formed on the metal layer (I) by vapor deposition or electroplating. At least one insulative film layer of a non-thermoplastic polyimide resin may be provided on the metal conductor layer.

### TECHNICAL FIELD

The present invention relates to a laminate having peelability for use as a substrate for a printed wiring board and as an electrode material or the like, and a production method therefor.

### BACKGROUND ART

Laminates including a metal foil such as a copper foil are often used as substrates for printed wiring boards and as nickel foil electrodes for capacitors. A copper clad laminate to be used as a printed wiring board substrate, for example, is a laminate including an insulative base such as a glass/epoxy base, a phenol/paper base or a film base of a polyimide, and a copper foil serving as a metal conductor bonded to the insulative base. In production of the laminate, a so-called “metal foil/carrier material” including a backing called “carrier” and a metal foil provided on the backing is used for easy handling of the thin metal foil.

The carrier of the metal foil/carrier material is a metal or resin sheet serving as the backing. The carrier is required to have a certain heat resistance and strength for protection of the copper foil in the production of the laminate. The metal foil backed with the carrier of the metal foil/carrier material is bonded to the insulative base. Thereafter, the carrier is removed from the surface of the metal foil/carrier material, and the remaining metal foil/insulative base structure is used for various applications.

The copper clad laminate for use as the printed wiring board substrate is generally produced by a hot press method. More specifically, a plurality of so-called stacks each prepared by stacking a copper foil and an insulative base are laid up, then placed between a pair of hot plates of a press machine, and pressed between the hot plates in a high temperature atmosphere and, as required, at a reduced pressure, whereby the copper foil is bonded to and unified with the insulative base. Thus, the copper clad laminate is produced.

Problems associated with this process include wrinkling of the copper foil, and intrusion of ambient foreign matter between the stacks. These problems result in reduction in the yield of the copper clad laminate.

With the recent trend toward size reduction and higher functionality of electric and electronic apparatuses, the printed wiring board substrates are increasingly required to have a smaller thickness and a higher density design. To this end, an attempt is made to reduce the thickness of the copper foil of the copper clad laminate to form a minute circuit pattern for higher density interconnection. However, a copper foil having a reduced thickness is more liable to be wrinkled during the stacking in the production of the copper clad laminate. Thus, the reduction in the thickness of the copper foil tends to reduce the yield of the copper clad laminate in the hot press process as described above. This is well known to those skilled in the art. Nevertheless, the copper foil/carrier material is still used in this field of application.

The metal foil/carrier material is classified into two categories depending on a carrier removal method. Examples of the carrier removal method include a method in which only the carrier is physically peeled off, and a method in which only the carrier is etched away by a chemical agent capable of selectively dissolving the carrier. In general, the former method is referred to as a peelable type method, while the latter method is referred to as an etchable type method. Further, a metal foil/carrier material utilizing the peelable type method is referred to as a metal foil material of a peelable type, while a metal foil/carrier material utilizing the etchable type method is referred to as a metal foil material of an etchable type.

In consideration of use convenience, the peelable type is preferred. A conventional metal foil material of the peelable type includes a release layer (also referred to as “separation layer” or “bonding interface layer”) provided between the carrier and the metal foil for peelability. However, thermal degradation of the release layer in the hot press process will cause problems such that the metal foil material has unstable peel strength and a limited use temperature.

The metal foil/carrier material of the peelable type is generally produced by the following two production methods. One of the methods is to separately prepare a metal foil and a carrier and bond the metal foil and the carrier to each other. The other method is to electrically deposit a metal foil on a carrier by a wet method or an electroplating method. In either of the production methods, an attempt is made to solve the aforementioned problems associated with the metal foil material of the peelable type by giving consideration to the release layer provided between the metal foil and the carrier.

JP2004-169181A, for example, proposes that a layer of a phosphorus-containing copper metal or copper alloy formed by strike plating is provided between a copper foil and a separation layer of a copper foil material of the peelable type. Further, JP2003-181970A proposes that a bonding interface layer including a metal oxide layer and an organic agent layer is provided in an interface between a carrier foil and a copper foil to solve the aforementioned problems.

Thus, metal foil materials of the peelable type having stable peelability are provided. However, the metal foil materials are insufficient in heat resistance. In addition, the production methods still suffer from problems with poorer mass productivity and with a complicated release layer formation step.

A known flexible printed wiring board substrate is typically produced by bonding an insulative layer of a polyimide film to a metal conductor layer with an adhesive such as of an epoxy resin or an acryl resin. In the known flexible printed wiring board substrate, the metal conductor layer is provided, for example, on at least one of opposite surfaces of the insulative layer with the intervention of the adhesive such as of the epoxy resin or the acryl resin. However, this substrate is poorer in heat resistance, flame resistance and electrical properties because the adhesive is present between the metal conductor layer and the insulative layer.

A solution to this problem is proposed, in which a thermoplastic polyimide having adhesion properties generated by means of thermocompression is used for an adhesive layer in the stacking of the metal conductor layer on the polyimide film (JP2000-103010A). However, this arrangement is insufficient in improvement of the heat resistance, the flame resistance and the electrical properties, because a material that directly contacts the metal conductor is the thermoplastic polyimide.

A known method of producing a flexible printed wiring board substrate of a double layer structure is such that a metal layer serving as a conductor layer is provided directly on a film (sputtering/plating method) The substrate produced by this method includes no adhesive between the metal conductor layer and the insulative layer and, therefore, the resulting flexible printed wiring board is expected to be free from problems occurring due to the adhesive. However, it is difficult to provide sufficient adhesion between the film and the metal layer, because the metal layer is formed on the film by vacuum vapor deposition or plating. To cope with this, an attempt is made to activate the surface of the film by an etching process to provide sufficient adhesion. However, a flexible printed wiring board substrate having sufficient adhesion is not provided yet. This method is advantageous for forming the metal layer in any desired thickness. Particularly, this method is advantageous in that the metal layer or the metal conductor layer can be formed as having a smaller thickness to meet a recent requirement for higher density integration on the flexible printed wiring board.

Another known method employing no adhesive is to form a resin layer such as of a polyimide on a metal foil by coating (casting method). In this method, the resulting coating film is heat-treated to be cured for the formation of the insulative layer. Therefore, the resulting flexible printed wiring board has excellent properties with sufficient adhesion between the metal foil and the insulative layer. However, the metal foil is employed as a starting material, so that thickness reduction of the conductor layer for the higher density integration has a limitation. The inventors of the present invention know that, where a copper foil having a thickness less than 9 μm is employed as the starting material for the formation of the conductor layer, for example, it is very difficult to produce the substrate on an industrial basis with the use of the copper foil.

JP2004-009357A proposes a laminate including a film base (carrier) having a release layer, a vapor deposition metal layer and a plating layer provided on the film base, and a polyimide layer provided on the plating layer. This arrangement provides a flexible printed wiring board substrate which has a double layer structure including virtually no adhesive layer. However, a release layer provided for separation of the film base from the metal layer is poor in heat resistance.

As a result, the insulative layer has insufficient properties with unsatisfactory heat resistance.

### DISCLOSURE OF THE INVENTION

### Problems to be Solved by the Invention

In view of the foregoing, it is an object of the present invention to provide a laminate which includes virtually no release layer between a very thin metal foil and a carrier serving as a base and is excellent in heat resistance and peelability, and to provide a production method for the laminate.

### Means for Solving the Problem

As a result of intensive studies conducted to solve the aforementioned problems, the inventors of the present invention found that a laminate having stable peelability can be provided by using a heat resistant base as a carrier and forming a very thin metal conductor layer directly on a surface of the base, and attained the present invention.

The present invention has the following features:

(1) A laminate comprises a heat resistant base and a metal conductor layer provided on at least one surface of the heat resistant base, and the heat resistant base is peelable from the metal conductor layer;
(2) In the laminate (1), no release layer is present between the heat resistant base and the metal conductor layer;
(3) The laminate (1) or (2) has a peel strength of not greater than 0.5 kN/m at an interface between the heat resistant base and the metal conductor layer;
(4) In the laminate (1) or (2), the metal conductor layer has a thickness not less than 0.1 μm and not greater than 9 μm;
(5) In the laminate (1) or (2), the heat resistant base is a metal foil;
(6) In the laminate (1) or (2), the heat resistant base is a film of a non-thermoplastic polyimide resin;
(7) In the laminate (1) or (2), the metal conductor layer comprises a vapor deposition metal layer and/or a plating metal layer;
(8) In the laminate (1) or (2), the metal conductor layer comprises a metal layer (I) formed in an interface with the heat resistant base by vapor deposition, and at least one metal layer (II) formed on the metal layer (I) by vapor deposition or electroplating;
(9) In the laminate (8), the metal layer (I) has a thickness of 0.01 to 2 μm;
(10) In the laminate (8), the metal layer (I) and the metal layer (II) are each composed of a metal selected from the group consisting of copper, nickel, zinc, tin, chromium, cobalt, titanium, platinum, gold and silver, and alloys of any of these metals;
(11) The laminate (1) further comprises at least one insulative film layer of a non-thermoplastic polyimide resin provided on the metal conductor layer;
(12) A laminate comprises a pair of laminates of (11) combined together with their insulative film layers being bonded to each other;
(13) A laminate wherein the heat resistant base is peeled off from the laminate (11) or (12);
(14) A flexible printed wiring board substrate comprises the laminate (13);
(15) An electronic component comprises the laminate (13) to define at least one of a capacitor electrode component, a capacitor and a secondary battery;
(16) A method of producing any one of the laminates (1) to (12) comprises the step of forming a metal conductor layer on at least one surface of a heat resistant base by vapor deposition and/or plating; and
(17) A method of producing any one of the laminates (1) to (12) comprises the steps of forming a metal layer (I) by depositing a metal on at least one surface of a heat resistant base by vapor deposition, and forming a metal layer (II) by depositing a metal on the metal layer (I) by vapor deposition or electroplating.

### EFFECTS OF THE INVENTION

According to the present invention, the laminate is provided, which includes the very thin metal conductor layer provided directly on the heat resistant base and has excellent peelability at the interface between the heat resistant base and the metal conductor layer.

Since the inventive laminate has peelability at the interface between the heat resistant base and the metal conductor layer, the heat resistant base can be easily peeled off as required. That is, this laminate is advantageously used as a so-called peelable type metal foil material.

The heat resistant base can be the metal foil or the non-thermoplastic polyimide resin film. Therefore, the metal conductor layer has a smooth surface free from voids and defects.

Since no heat-labile release layer is present in the interface between the heat resistant base and the metal conductor layer, the laminate is free from the problems occurring due to the presence of the heat-labile release layer during high temperature pressing. Thus, the laminate has stable heat resistance and peelability.

Therefore, the use of the laminate provides the following advantages. For example, a process temperature for the pressing can be set at a higher level. In the absence of the heat-labile release layer, there is no need to give consideration to the chemical resistance of the release layer. This eliminates limitations associated with chemical agents to be used in the process. Therefore, the laminate is a material advantageous for production of a polyimide/copper clad laminate that requires hot-pressing at a relatively high temperature of 300° C. to 380° C. for use as a printed wiring board substrate and for a fluororesin/copper clad laminate.

According to the inventive laminate production method, the laminate including the very thin metal conductor layer and having peelability at the interface between the heat resistant base and the metal conductor layer can be easily produced with higher productivity.

Since the inventive laminate is excellent in heat resistance, it is possible to form an insulative film layer of a non-thermoplastic polyimide by applying a solution of a non-thermoplastic polyimide precursor directly on the metal conductor layer and imidizing the precursor at a high temperature. The non-thermoplastic polyimide is excellent in flame resistance, dimensional stability and electrical properties. Thus, the insulative film layer having such excellent properties can be provided in the laminate.

According to the present invention, the two laminates each including the insulative film layer are combined together with their insulative film layers being bonded to each other with an adhesive or the like, whereby a laminate including metal conductor layers provided on opposite surfaces of the insulative film layers can be easily produced.

A laminate having a metal conductor layer/insulative film layer structure can be easily produced by peeling off the heat resistant base from the laminate including the insulative film layer. This laminate can be used as a material for production of a copper clad laminate. The laminate is also advantageous as a material for a component to be provided with a very thin metal foil. Examples of the component include electrode components for film capacitors and thin film capacitors, electrode components for capacitors and secondary batteries, electromagnetic shield components for flat panel display devices, electrode components for fuel batteries, terminal components for connectors, electrode components for solar battery panels, and other components to be used in the filed of electric and electronic apparatuses. Particularly, the laminate is advantageously used as a substrate for a flexible printed wiring board, as an electrode material for a capacitor, or as other material for a capacitor or a secondary battery. The laminate including metal conductor layers provided on the opposite surfaces of the insulative film layers is advantageously used as a substrate for a flexible printed wiring board of a double sided structure.

### BEST MODE FOR CARRYING OUT THE INVENTION

The present invention will hereinafter be described in detail.

The inventive laminates and the inventive laminate production method are broadly categorized into the following four groups:

Group I A laminate having a heat resistant base/metal conductor layer structure;
Group II A laminate having a heat resistant base/metal conductor layer/insulative film layer structure;
Group III A laminate having a metal conductor layer/insulative film layer structure; and
Group IV A method of producing the laminate (Group-I laminate) having the heat resistant base/metal conductor layer.

The Group-I laminate has a layered structure including a heat resistant base and a metal conductor layer.

The heat resistant base is a backing material which prevents the metal conductor layer from being wrinkled or folded during handling of the inventive laminate, and is generally called “carrier.”

The laminate should be arranged such that the heat resistant base can be industrially easily peeled off from the metal conductor layer. That is, the heat resistant base should be peelable from the metal conductor layer according to the present invention. The term “peelable” or the expression “having peelability” to be used for the present invention means a property such that self-peeling does not occur at an interface between the heat resistant base and the metal conductor layer in a laminate production process or in a process using the laminate, but interfacial peeling definitely occurs at the interface between the heat resistant base and the metal conductor layer without material breakdown in the respective layers of the inventive laminate when the heat resistant base is wound while being separated from a roll formed by winding the inventive laminate by means of a rewinder or a like film machine. This state is often called “peelable” by those skilled in the art (e.g., JP2002-33581A).

More specifically, the laminate preferably has, as an index of the peelability, an upper limit peel strength of not greater than 0.5 kN/m, more preferably not greater than 0.3 kN/m, further more preferably not greater than 0.2 kN/m, still more preferably not greater than 0.1 kN/m, and a lower limit peel strength of not less than 0.01 kN/m, more preferably not less than 0.02 kN/m, further more preferably not less than 0.03 kN/m, at the interface between the heat resistant base and the metal conductor layer.

The peel strength is determined by dividing an average stress measured in the following manner by the width of a specimen. End portions of layers of a specimen cut to a size of 150 mm (length)×10 mm (width) are preliminarily separated to a length of about 30 mm from each other along a peel interface. This sample is fixed to a slidable support jig similar to that shown in JIS-C6471-8.1 by a double sided adhesive tape. The slidable support jig is attached to a tensile tester (available from Intesco Co., Ltd.), and an unfixed one of the end portions is fixed to a gripper, which is in turn moved up at a speed of 50 mm/min. Stress values observed when the end portions are further separated from each other at an angle of 90 degrees are recorded.

The heat resistant base is not particularly limited, as long as it has heat resistance as will be described later and is provided in the form of a flexible sheet. The heat resistant base preferably has a smooth surface. Where the heat resistant base is a smooth sheet, the metal conductor layer formed on the base has a highly smooth surface.

The heat resistant base may be inorganic or organic.

Examples of the inorganic heat resistant base include inorganic sheets such as metal foils, carbon sheets and ceramic sheets.

The term “heat resistance” herein means that the inorganic sheets are free from thermal deformation and thermal degradation in a heat treatment during the processing of the inventive laminate. The inorganic sheets should be free from deformation and degradation, for example, in an atmosphere at 300° C.

Among the inorganic sheets, the metal foils are preferred. Examples of the metal foils include a copper foil, an aluminum foil, a stainless steel foil and a nickel foil. Among these metal foils, a metal foil having an oxide film layer formed in its surface by natural oxidation is particularly preferred. Examples of such a metal foil include a copper foil and an aluminum foil. The copper foil and the aluminum foil are each naturally oxidized by atmospheric oxygen in an ordinary ambient atmosphere and, therefore, each have a very thin oxide film on a surface thereof. In general, where a metal conductor layer is formed on the copper foil or the aluminum foil, the metal conductor layer is essentially provided on an oxide film layer. Therefore, the oxide film layer serves as a release layer, so that the laminate supposedly has peelability as will be described later.

Examples of the organic heat resistant base include films of heat resistant resins such as polyimide resins, polyamide-imide resins, polybenzoxazole resins and aramide resins.

According to the present invention, the term “heat resistance” means that the heat resistant resin films each have a glass transmission temperature not lower than 250° C., more preferably not lower than 300° C., particularly preferably not lower than 350° C., as measured by DSC measurement.

The resin films are preferably non-thermoplastic resin films, which are generally less liable to be thermally deformed. According to the present invention, the term “non-thermoplastic” means that the glass transition is not observed in a temperature range not higher than 350° C. in the DSC measurement.

Preferred examples of the heat resistant resin films include non-thermoplastic polyimide resin films. Specific examples of such films include CAPTON™ and UPIREX S™, which are commercially available. Besides, a non-thermoplastic polyimide resin to be used for an insulative film layer as will be described later may be used for the heat resistant base.

For the peelability described above, the peel interface of the heat resistant base may be subjected to any of various surface treatments, e.g., subjected to a dry etching process or a wet etching process, or coated with a heat resistant release agent.

The studies conducted by the inventors of the present invention reveal that a film of a non-thermoplastic polyimide resin, a copper foil or an aluminum foil each subjected to no surface treatment is particularly preferred as the heat resistant base. As described above, copper and aluminum are each naturally oxidized by atmospheric oxygen and, therefore, each have a very thin oxide film formed on a surface thereof. A copper foil and an aluminum foil produced by an ordinary method each have an oxide film layer, which serves as a release layer. Therefore, the copper foil and the aluminum foil supposedly each have peelability without particular need for the surface treatment.

The heat resistant base may have a layered structure including a plurality of layers of any of the aforementioned materials in combination. For example, the heat resistant base may be a laminate sheet including a metal foil and a non-thermoplastic polyimide layer, or a laminate sheet prepared by thermally spraying a ceramic material on a metal foil.

The thickness of the heat resistant base is not particularly limited, but is preferably in the range of 12 to 600 μm in consideration of the function of the heat resistant base which serves as a reinforcement material during the handling of the inventive laminate. An optimum thickness of the base may be selected within the aforementioned range according to the material for the base, because properties such as flexibility vary from material to material. If the thickness is less than 12 μm, the resulting laminate tends to have poor handlability. That is, the heat resistant base serving as the carrier is easily deformed during handling thereof and, therefore, the metal conductor layer tends to be irrecoverably wrinkled or folded. For this reason, the heat resistant base particularly preferably has a thickness not less than 25 μm. If the thickness is less than 25 μm, the resulting laminate tends to suffer from problems such as wrinkling and tearing when being handled, e.g., when being wound around a paper tube. If the thickness is greater than 600 μm, the laminate has unnecessarily excessive rigidity for the backing material, resulting in poor operability in peeling the heat resistant base. That is, the peeling operation is performed by peeling the heat resistant base while flexing the base. However, an excess force is required to flex the heat resistant base when the base is peeled off. This makes it difficult to peel off the base.

The metal conductor layer can be easily formed on the aforementioned heat resistant base as having a very small thickness as will be described later by metal vapor deposition such as vacuum vapor deposition or sputtering, or by electroplating. According to the present invention, the term “vapor deposition” generally means a method of physically forming a metal film on a dry basis. Examples of the method include a vacuum vapor deposition method in which a metal is vaporized or sublimated at a high temperature in a vacuum and deposited on the base, a sputtering method in which ionized argon is applied to a metal in a vacuum to sputter metal atoms which are in turn deposited on the base, an ion plating method, a laser abrasion method, an ion beam deposition method, an ion implantation method and a CVD method.

A metal for the metal conductor layer is not particularly limited, as long as the metal is electrically conductive. Examples of the metal include copper, nickel, tin, chromium, cobalt, titanium, zinc, silver, gold, platinum and palladium, and alloys containing a plurality of metals selected from these exemplary metals and other metal elements.

The metal conductor layer may have a layered structure including layers of different metals. The layered structure may be formed by performing an electrolytic plating process on a surface of a metal vapor deposition layer, by performing a non-electrolytic plating process in addition to the electrolytic plating, or by superposing another vapor deposition layer on the metal vapor deposition layer. An alloy containing nickel, chromium, zinc and the like may be vapor-deposited to a thickness on the order of nanometer on the surface of the metal layer, for example, for prevention of oxidation of the metal layer.

Particularly, the metal conductor layer preferably includes a metal layer (I) formed on the surface of the heat resistant base by vapor deposition, and a metal layer (II) formed on the metal layer (I) by vapor deposition or electroplating. The metal layer (I) is formed directly on the surface of the specific heat resistant base by a vapor deposition method on a dry basis, whereby the laminate has stable peelability at the interface between the heat resistant base and the metal conductor layer. It is a conventional practice for those skilled in the art to form a layer of a third component, i.e., a so-called release layer (also called “separation layer” or “bonding interface layer”), in the interface between the base and the metal conductor layer for the peelability. In the present invention, however, the metal layer (I) formed on the surface of the heat resistant base by the vapor deposition provides excellent peelability without substantial need for the provision of a layer equivalent to the release layer.

The metal layer (I) preferably has a thickness of 0.01 to 2 μm, more preferably 0.05 to 1 μm. If the thickness is less than 0.01 μm, it will be difficult to provide stable peelability. In contrast, if the thickness is greater than 2 μm, the productivity will be reduced with a longer period required for the vapor deposition.

Vapor deposition or plating such as electroplating is preferably employed for the formation of the metal layer (II) on the metal layer (I). At this time, a plurality of layers of different metals may be formed as required by repeating the vapor deposition or the plating.

The metals to be used for the metal layer (I) and the metal layer (II) are selected from the metals described above for the metal conductor layer.

The thickness of the overall metal conductor layer is preferably in the range of 0.1 to 9 μm, more preferably 0.5 to 9 μm, further more preferably 0.5 to 7.5 μm, still more preferably 2 to 5 μm. If the thickness is less than 0.1 μm, the film to be formed by the electrolytic plating is liable to be uneven, so that pinholes tend to occur in some regions. If the thickness is greater than 9 μm, the productivity will be reduced with a longer period required for the layer formation. In addition, where the inventive laminate is used as a substrate for a flexible printed wiring board, it will be difficult to form a minute circuit on the substrate.

The surface roughness of the interface between the heat resistant base and the metal conductor layer of the laminate tends to influence the peelability. That is, if the surface of the heat resistant base has greater surface roughness, the adhesion at the interface is generally increased by the anchoring effect, but this has a negative effect on the object of the present invention. The rough surface profile of the heat resistant base is reflected on the smoothness of the surface of the metal conductor layer in contact with the heat resistant base. Therefore, the surface of the heat resistant base on which the metal conductor layer is stacked is preferably as smooth as possible. From an opposite aspect, the peelability can be controlled as desired by controlling the surface roughness of the heat resistant base.

The inventive laminate production method of Group IV will be described.

First, the metal layer (I) is formed on the surface of the heat resistant base by the vapor deposition. Prior to the vapor deposition, a cleaning process may be performed to remove smear such as greasy matter and organic matter from the surface of the heat resistant base. However, this process is often disadvantageous, because there is a possibility that the heat resistant base per se is dissolved by cleaning with a cleaning agent containing an acid or an alkali. Cleaning with a neutral cleaning agent or cleaning with an organic solvent is preferred.

The vapor deposition metal layer (I) is formed on at least one surface of the heat resistant base. A surface of the base to be formed with no metal layer may be subjected to a masking process or the like for prevention of formation of the vapor deposition metal layer thereon.

In turn, the metal layer (II) is formed on the surface of the metal layer (I). The formation of the metal layer (II) is achieved by vapor deposition, or by a wet method such as chemical plating or electroplating. In general, a sputtering method ensures more efficient formation of a thick film than the vacuum vapor deposition. A more uniform metal layer free from thick spots can be formed by the sputtering method or the ion plating method rather than by the vacuum vapor deposition. In the present invention, the method for the vapor deposition may be selected as appropriate.

As required, metal layers may be stacked by repeated vapor deposition or repeated plating. At this time, a roughening process may be performed by forming a rough layer with minute metal particles deposited by bumpy plating and then covering the metal particles by plating.

After washing with water, a surface treatment may be performed with the use of an antirust agent or a coating agent such as a silane coupling agent. In general, the treatment can be easily performed by dipping an object in the coating agent and then drying the object. The thickness of the resulting coating film can be controlled by adjusting the concentration of the coating agent.

Next, the laminate of Group II will be described.

The laminate of Group II includes at least one insulative film layer such as of a non-thermoplastic polyimide resin provided on the metal conductor layer of the laminate of Group I. The laminate has a heat resistant base/metal conductor layer/insulative film layer structure.

Two laminates each including a heat resistant base, a metal conductor layer and an insulative film layer may be combined together with their insulative film layers being opposed to each other to provide a second laminate. The second laminate has a heat resistant base/metal conductor layer/insulative film layer/metal conductor layer/heat resistance base structure.

In general, the surface of the metal conductor layer to be formed with the insulative film layer, if untreated, tends to have insufficient interface adhesion to the non-thermoplastic polyimide resin or the like to be used as an insulative material. Where the metal conductor is copper, for example, a very thin copper oxide film is formed on a copper surface by natural oxidation, thereby reducing the interface adhesion strength. Therefore, the provision of an antirust layer on the surface of the metal conductor layer is effective for improvement of the interface adhesion. Exemplary materials for the antirust layer include nickel, chromium, zinc and molybdenum, and alloys containing any of these metals.

For the improvement of the antirust property and the peel strength, the surface of the metal conductor layer may be subjected to various treatments other than the aforementioned treatment. For example, a rough layer may be provided as having minute metal particles deposited by bumpy plating, and the metal particles are further covered by plating for prevention of dislodgement thereof. The provision of the antirust layer improves the interface peel strength.

The surface of the metal conductor layer may be treated with a chemical agent. A benzotriazole or an imidazole may be used as the antirust agent for coating, and a silane coupling agent may be used as an adhesion improving agent for coating. Further, the roughening of the surface may be achieved by soft etching with a chemical agent.

The insulative film layer to be formed on the metal conductor layer preferably includes at least a film of a non-thermoplastic polyimide resin. A single film layer of the non-thermoplastic polyimide resin may be provided. Alternatively, resin layers of different chemical structures may be stacked for improvement of properties (curl property, for example) of the laminate. However, the thickness ratio of the non-thermoplastic polyimide resin layer to the insulative film layer is preferably not less than 60% to provide the heat resistance and the dimensional stability.

The term “polyimide resin” herein means a resin containing imide groups in its main chain skeleton. Examples of the polyimide resin include homopolymers such as polyimides, polybenzoxazole imides, polyamide imides, polyether imides, polyester imides and polysiloxane imides, and copolymers of polyimides and any of polybenzoxazole, polyamides, polyamide imides, polyether imides, polyester imides and polysiloxane imides, among which the polyimides are most preferred as the non-thermoplastic polyimide resin.

The non-thermoplastic polyimide resin is preferably a wholly aromatic polyimide resin, and has a structure represented by the following structural formula (1):

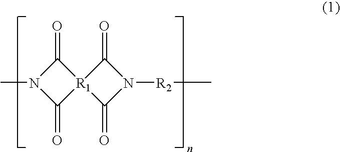

wherein R₁ is a tetravalent aromatic residue, and R₂ is a divalent aromatic residue.

The film layer of the non-thermoplastic polyimide resin can be formed, for example, by applying a solution of a polyimide precursor onto the metal conductor layer, and drying and thermally setting the resulting polyimide precursor film. The polyimide precursor is herein defined as any compound that is thermally set to provide a polyimide having the structural formula (1). An example of the polyimide precursor is a polyamic acid represented by the following structural formula (2). The polyimide precursor solution typically contains the polyamic acid and a solvent.

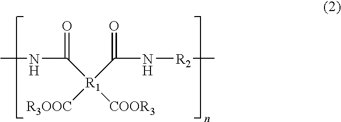

wherein R₁ is a tetravalent aromatic residue, R₂ is a divalent aromatic residue, and R₃ is a hydrogen atom or an alkyl group.

The solution containing the polyamic acid is prepared by causing an aromatic tetracarboxylic dianhydride represented by the following structural formula (3) and an aromatic diamine represented by the following structural formula (4) to react with each other in a solvent, e.g., an aprotic polar solvent such as N,N-dimethylacetamide.

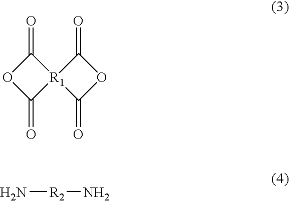

wherein R₁ is a tetravalent aromatic residue, and R₂ is a divalent aromatic residue.

In the aforementioned reaction, the proportion of the aromatic tetracarboxylic dianhydride per mole of the aromatic diamine is preferably in the range of 1.03 to 0.97 moles. The proportion of the aromatic tetracarboxylic dianhydride per mole of the aromatic diamine is more preferably in the range of 1.01 to 0.99 moles. A reaction temperature is preferably −30° C. to 60° C., more preferably −20° C. to 40° C.

In the aforementioned reaction, the order of adding the monomer and the solvent is not particularly limited, but may be any order. Where a solvent mixture is used as the solvent, the solution of the polyamic acid may be prepared by dissolving or suspending different monomers in different solvents, mixing the resulting solutions or suspensions together, and causing the monomers to react with each other at a predetermined temperature for a predetermined period with stirring. Two types of polyimide resin precursor solutions may be mixed together for use.

Specific examples of the aromatic tetracarboxylic dianhydride represented by the above structural formula (3) include dianhydrides of pyromellitic acid, 3,3′,4,4′-biphenyltetracarboxylic acid (BPDA), 3,3′,4,4′-benzophenone tetracarboxylic acid, 3,3′4,4′-diphenylsulfone tetracarboxylic acid, 2,3,3′,4′-diphenylether tetracarboxylic acid, 2,3,3′,4′-benzophenone tetracarboxylic acid, 2,3,6,7-naphthalene tetracarboxylic acid, 1,4,5,7-naphthalene tetracarboxylic acid, 1,2,5,6-naphthalene tetracarboxylic acid, 3,3′,4,4′-diphenylmethane tetracarboxylic acid, 2,2-bis(3,4-dicarboxyphenyl)propane, 2,2-bis(3,4-dicarboxyphenyl)hexafluoropropane, 3,4,9,10-tetracarboxyperylene, 2,2-bis[4-(3,4-dicarboxyphenoxy)phenyl]propane and 2,2-bis[4-(3,4-dicarboxyphenoxy)phenyl]hexafluoropropane. Two or more of these aromatic tetracarboxylic dianhydrides may be mixed together for use. In the present invention, pyromellitic dianhydride or 3,3′4,4′-biphenyltetracarboxylic dianhydride, or a mixture of these dianhydrides is particularly preferably used.

Specific examples of the aromatic diamine represented by the above structural formula (4) include p-phenylenediamine, m-phenylenediamine, 3,4′-diaminodiphenylether, 4,4′-diaminodiphenylether, 4,4′-diaminodiphenylmethane, 3,3′-dimethyl-4,4′-diaminodiphenylmethane, 2,2-bis[4-(4-aminophenoxy)phenyl]propane, 1,2-bis(anilino)ethane, diaminodiphenylsulfone, diaminobenzanilide, diaminobenzoate, diaminodiphenylsulfide, 2,2-bis(p-aminophenyl)propane, 2,2-bis(p-aminophenyl)hexafluoropropane, 1,5-diaminonaphthalene, diaminotoluene, diaminobenzotrifluoride, 1,4-bis(p-aminophenoxy)benzene, 4,4′-bis(p-aminophenoxy)biphenyl, diaminoanthraquinone, 4,4′-bis(3-aminophenoxyphenyl)diphenylsulfone, 1,3-bis(anilino)hexafluoropropane, 1,4-bis(anilino)octafluorobutane, 1,5-bis(anilino)decafluoropentane and 1,7-bis(anilino)tetradecafluoroheptane. Two or more of these aromatic diamines may be mixed together for use. In the present invention, p-phenylenediamine or 4,4′-diaminodiphenylether, or a mixture of these diamines is particularly preferred.

In the present invention, a derivative of an amine, a diamine, a dicarboxylic acid, a tricarboxylic acid and/or a tetracarboxylic acid having a polymerizable unsaturated bond may be added to the polyimide precursor solution for formation of a crosslink structure in the thermal setting for the preparation of the polyimide precursor solution. Specific examples of the acid derivative include maleic acid, nadic acid, tetrahydrophthalic acid and ethynylaniline.

Even if a partially imidized portion is present in the polyimide resin precursor due to conditions for synthesis and drying of the polyimide resin precursor and for other reasons, there is no particular problem.

In the preparation of the solution of any of the polyimide resin precursors, a polyimide resin, a polyamide imide resin or a like heat resistant resin soluble in the aforementioned solvent may be mixed with the solution. Further, a very small amount of a silane coupling agent or a surface active agent may be added to the polyimide resin precursor solution for improvement of the adhesion (stickiness) and film properties.

For improvement of the dimensional stability and the film properties, a particulate filler may be blended in the polyimide resin precursor solution. The particulate filler is not particularly limited, but a filler that is heat resistant and free from thermal deterioration during the thermal setting of the polyimide precursor is preferred. Examples of the particulate filler include particles of silica, mica, graphite, carbon black, alumina, boron nitride, aluminum nitride, silicon nitride, silicon carbide, fluororesins, polyimide resins, polyamide imide resins, magnesium oxide and other metals. The amount of the particulate filler to be blended may be such that the insulative property and other properties are not impaired. In general, the amount of the filler is 0.5 to 60 parts by mass based on 100 parts by mass of the insulative film layer. If the amount is less than 0.5 parts by mass, the effect of the addition of the particulate filler is not apparent. If the amount is greater than 60 parts by mass, the insulative property and the film properties tend to be adversely affected.

As described above, the two laminates are combined together with their insulative films being bonded to each other with an adhesive, whereby the second laminate including the metal conductor layers formed on opposite surfaces of the insulative film layers is provided. By removing the outermost heat resistant bases from the second laminate, a flexible printed wiring board substrate (double-sided copper clad laminate) having the metal conductor layers on its opposite surfaces can be provided.

The adhesive to be used is not particularly limited, but preferably has heat resistance required for the flexible printed wiring board and withstands heat press bonding. Examples of the adhesive include thermoplastic polyimides, thermosetting polyimides and epoxy resins.

For the bonding, the adhesive is applied onto one or both of the insulative film layers of the laminates and dried to form adhesive layers, and then the laminates are bonded to each other by a known method with the use of a single-plate vacuum press or a roll laminator or the like.

Next, the laminate of Group III will be described.

The laminate is produced by removing the heat resistant base from the laminate of Group II, and includes the metal conductor layer and the insulative film layer. This laminate is excellent in various properties such as heat resistance, dimensional stability and flexural endurance, and permits formation of a minute circuit. The laminate can be used as a material for the copper clad laminate. The laminate is advantageous as a material for a component having a very thin metal foil. Examples of the component include electrode components for film capacitors and thin film capacitors, electrode components for capacitors and secondary batteries, electromagnetic shield components for flat panel display devices, electrode components for fuel batteries, terminal components for connectors and electrode components for solar battery panels in the field of electric and electronic apparatuses. Particularly, the laminate is advantageously used as a substrate for a flexible printed wiring board, as an electrode material for a capacitor, or as other material for a capacitor or a secondary battery. As described above, the laminate including the metal conductor layers provided on the opposite surfaces of the insulative film layers is advantageously used as the flexible printed wiring board substrate of the double sided structure.

The inventive flexible printed wiring board substrate is formed with a circuit and mounted with components, whereby a flexible printed wiring board is produced, which is in turn used for an electronic apparatus, a communication apparatus, a control apparatus, a domestic appliance, an automotive component, a aircraft component, a medical apparatus or the like in the electric/electronic field.

### EXAMPLES

The present invention will be described more specifically by way of examples. However, it should be understood that the present invention be not limited to the examples.

In the following examples and comparative example, measurement methods for various properties are as follows:

### (1) Evaluation of Peelability (Hot Press Test)

A film piece having a size of 250 mm square was prepared by cutting a polyimide film (VT25 available from Ube Industries, Ltd., and having a thickness of 25 μm) having thermoplastic polyimide adhesive layers provided on opposite surfaces thereof, and laminates (each having a metal conductor layer provided on a heat resistant base but having no insulative polyimide film layer) were placed on the opposite surfaces with their metal conductor layers facing to the polyimide film piece to provide a stack. In this manner, five such stacks were prepared, and laid up. Stainless steel mirror-finished plates each having a thickness of 1.5 mm were placed on the outermost opposite surfaces of the resulting lay-up, and placed between hot plates of a press machine (a 200-ton vacuum press machine available from Kitagawa Seiki Co., Ltd.).

In turn, an ambient pressure was reduced to 1.33 kPa (10 Torr). The lay-up was pressed at a pressure of 3 MPa by moving the upper and lower hot plates toward each other, and this pressed state was maintained. At the same time, the upper and lower hot plates were heated and, after the surface temperatures of the hot plates were stabilized at 350° C., the lay-up was kept pressed at 350° C. at 3 MPa for 30 minutes. Then, the hot plates were cooled down to about 80° C., while the lay-up was kept pressed.

After the lay-up was released from the pressure and the ambient pressure was returned to the atmospheric pressure, the lay-up was taken out. Then, whether the layers of each of the stacks were unified into a laminate was checked. Further, the appearance of the laminate was checked.

In turn, the heat resistant bases serving as carriers were peeled off from opposite surfaces of the laminate. For the peeling, peeling tabs for removing only the heat resistant bases were each taken from one corner of the square laminate, and the laminate is generally horizontally placed on a flat platform. Then, only an upper one of the heat resistant bases was flexed and manually peeled off, while care is taken not to flex the resulting laminate. The other heat resistant base was also peeled off in the same manner.

The peelability of the laminate observed when the heat resistant bases were manually peeled off was evaluated. More specifically, a laminate from which only the carriers were peeled off without material breakdown at peel interfaces was rated as good. On the other hand, a laminate which suffered from material breakdown at the peel interferences or had difficulty in peeling was rated as bad.

(2) Peel Strength (kN/m)

The peel strength of the laminate at a peel interface was measured with the use of a tensile tester (a precision universal material tester MODEL 2020 available from Intesco Corporation). For the measurement, a test piece was prepared by cutting a test sample to a width of 10 mm and a length of 150 mm, and one of opposite surfaces of the test piece was fixed to a slidable support jig with the use of a double-sided adhesive tape having adhesive-applied opposite surfaces. Then, a peel strength at a bonding layer interface was determined based on an average stress observed when the other unfixed surface separated at the measurement interface was pulled at 90 degrees at a rate of 50 mm/min.

### (3) Thicknesses of Layers of Laminate

The thicknesses of respective layers of the laminate were determined based on a photograph taken by a transmission electron microscope (TEM JEM-1230 available from JEOL Ltd.)

### (4) Solder Heat Resistance Test

The resulting single-sided plate or double-sided plate was dipped in solder baths respectively maintained at 260° C., 280° C. and 300° C., and the state of the plate was observed.

### Polyimide Precursor Solutions

Polyimide precursor solutions used in the following examples and comparative example were prepared in the following manner.

(A) A homogeneous polyimide resin precursor solution containing a polyamic acid was prepared by stirring a mixture of 0.15 mol of 4,4′-oxydianiline, 0.85 mol of p-phenylenediamine and 3330 g of N-methyl-2-pyrrolidone for 30 minutes, then adding 1.00 mol of BPDA to the mixture, and stirring the resulting mixture in a 40° C. water bath for 1 hour. The polyimide resin precursor solution thus prepared is herein referred to as “polyimide precursor solution (A).”
(B) A homogeneous polyimide resin precursor solution containing a polyamic acid was prepared by stirring a mixture of 0.25 mol of 4,4′-oxydianiline, 0.75 mol of p-phenylenediamine and 3330 g of N-methyl-2-pyrrolidone for 30 minutes, then adding 1.00 mol of BPDA to the mixture, and stirring the resulting mixture in a 40° C. water bath for 1 hour. The polyimide resin precursor solution thus prepared is herein referred to as “polyimide precursor solution (B).”

### Example 1

A 50-μm thick non-thermoplastic polyimide film (UPIREX-50S available from Ube Industries, Ltd., and hereinafter referred to simply as “PI film”) was used as a heat resistant base, and a 0.2-μm thick copper layer was formed as a metal layer (I) on one surface of the film by sputtering. In turn, a 1.8-μm thick copper layer was formed as a metal layer (II) on the sputtered copper layer by electrolytic copper plating. Thus, a metal conductor layer of copper having a total thickness of 2.0 μm was formed. The polyimide precursor solution (A) was uniformly applied onto the metal conductor layer by a comma coater, and then dried at 140° C. until the viscosity of the solution was lost. The polyimide precursor was heated to 350° C. in a nitrogen gas atmosphere in an oven to be thereby cured into a polyimide. Thus, a 25-μm thick insulative film layer was formed. The glass transition of the insulative film layer was not observed at a temperature up to 350° C. as measured by DSC measurement. It was possible to properly handle the resulting laminate without wrinkling and folding.

### Example 2

The polyimide film serving as the heat resistant base was peeled off from the laminate obtained in Example 1. At this time, the peel strength at the peel interface was measured to be 0.08 kN/m. The peeling was easily achieved. As a result, a 27-μm thick substrate (one-sided plate) for a flexible printed wiring board was produced, which included the metal conductor layer of copper and the insulative film layer of the non-thermoplastic polyimide resin.

### Example 3

A 50-μm thick polyimide film (UPIREX-50S available from Ube Industries, Ltd.) was used as a heat resistant base, and a 0.2-μm thick copper layer was formed as a metal layer (I) on one surface of the polyimide film by sputtering. In turn, a 1.8-μm thick copper layer was formed as a metal layer (II) on the sputtered copper layer by electrolytic copper plating. The copper layers thus formed had a total thickness of 2.0 μm. Further, a 0.15-μm thick layer of a nickel-chromium alloy (a mass ratio of Ni/Cr=90/10) was formed on the copper layers for prevention of rust. The polyimide precursor solution (B) was applied on the metal conductor layer thus formed.

A 9-μm thick insulative film layer was formed in substantially the same manner as in Example 1 except for the aforementioned point. The glass transmission of the insulative film layer was not observed at a temperature up to 350° C. as measured by DSC measurement. It was possible to properly handle the resulting laminate without wrinkling and folding.

### Example 4

The polyimide film serving as the heat resistant base was peeled off from the laminate obtained in Example 3. At this time, the peel strength at the peel interface was measured to be 0.24 kN/m. The peeling was easily achieved. As a result, a 11-μm thick substrate (one-sided plate) for a flexible printed wiring board was produced, which included the metal conductor layer composed essentially of copper and the insulative film layer of the non-thermoplastic polyimide resin.

### Example 5

A 50-μm thick polyimide film (UPIREX-50S available from Ube Industries, Ltd.) was used as a heat resistant base, and a 1.0-μm thick copper layer was formed on one surface of the polyimide film by sputtering. Further, a 25-μm thick insulative film layer was formed on the resulting metal conductor layer in the same manner as in Example 1. It was possible to properly handle the resulting laminate without wrinkling and folding.

Then, the polyimide film serving as the heat resistant base was peeled off from the laminate as in Example 2. At this time, the peeling was easily achieved. Thus, a 26-μm thick substrate (one-sided plate) for a flexible printed wiring board was produced, which included the metal conductor layer of copper and the insulative film layer of the non-thermoplastic polyimide resin.

### Example 6

A 50-μm thick polyimide film (UPIREX-50S available from Ube Industries, Ltd.) was used as a heat resistant base, and a 0.2-μm thick copper layer was formed as a metal layer (I) on one surface of the polyimide film by sputtering.

In turn, a 4.8-μm thick copper layer was formed as a metal layer (II) on the sputtered copper layer by electrolytic copper plating. Thus, a metal conductor layer having a total thickness of 5.0 μm was formed. In this manner, a laminate was produced. Further, a 25-μm thick insulative film layer was formed on the metal conductor layer in the same manner as in Example 1. It was possible to properly handle the resulting laminate without wrinkling and folding.

Then, the polyimide film serving as the heat resistant base was peeled off from the laminate as in Example 2. At this time, the peeling was easily achieved. Thus, a 30-μm thick substrate (one-sided plate) for a flexible printed wiring board was produced, which included the metal conductor layer of copper and the insulative film layer of the non-thermoplastic polyimide resin.

### Example 7

An adhesive (ARON MIGHTY AS-60 available from Toagosei Co., Ltd.) composed essentially of an epoxy resin was applied onto a surface of the insulative film layer of the laminate of Example 1 by a roll coater, and then the applied adhesive was dried at 130° C. to form an adhesive layer. The adhesive layer had a thickness of 2 μm after the drying. Two such laminates were combined together with their adhesive layers being opposed to each other, and pressed at 150° C. at a pressure of 30 MPa for 30 minutes in a vacuum with the use of a vacuum single plate press machine to be thereby bonded to each other. It was possible to properly handle a newly obtained laminate without wrinkling. Polyimide films were peeled off from the outer opposite surfaces of the new laminate in the same manner as in Example 2, whereby a 58-μm thick substrate (double-sided plate) for a flexible printed wiring board was produced.

### Example 8

An adhesive layer was formed on a surface of the insulative film layer of the laminate of Example 3 in the same manner as in Example 7. The adhesive layer had a thickness of 1 μm after drying. Two such laminates were bonded to each other in the same manner as in Example 7. It was possible to properly handle a newly obtained laminate without wrinkling. Polyimide films were peeled off from the outer opposite surfaces of the new laminate in the same manner as in Example 2, whereby a 24-μm thick substrate (double-sided plate) for a flexible printed wiring board was produced.

### Example 9

A 1-μm thick non-thermoplastic polyimide layer was formed on one surface of a 50-μm thick aluminum foil (HTA foil available from Toyo Aluminum K.K.) by casting a solution of a non-thermoplastic polyimide precursor (U-VARNISH-S available from Ube Industries, Ltd.) on the surface and thermally setting the polyimide precursor. The resulting polyimide layer/aluminum foil sheet was used as a heat resistant base. A 2.0-μm thick copper layer and a 0.15-μm thick Ni/Cr alloy layer were formed on a surface of the polyimide layer of the heat resistant base in the same manner as in Example 3, and a 12-μm thick insulative film layer was formed with the use of the polyimide precursor solution (B).

It was possible to properly handle the resulting laminate without wrinkling and folding.

Further, the polyimide/aluminum sheet serving as the heat resistant base was peeled off from the laminate as in Example 2. At this time, the peeling was easily achieved. As a result, a 14-μm thick substrate (one-sided plate) for a flexible printed wiring board was produced, which included the metal conductor layer composed essentially of copper and the insulative film layer of the non-thermoplastic polyimide resin.

### Example 10

A 50-μm thick rolled aluminum foil (HA foil available from Toyo aluminum K.K.) was used as a heat resistant base, and a 0.4-μm thick copper layer was formed as a metal layer (I) on one surface of the foil by sputtering.

In turn, a 2.6-μm thick copper layer was formed as a metal layer (II) on the sputtered copper layer by electrolytic copper plating. The copper layers thus formed had a total thickness of 3.0 μm. In turn, a 0.15-μm thick layer of a nickel-chromium alloy (having a mass ratio of Ni/Cr=90/10) was formed on the copper layers by vapor deposition for prevention of rust. Further, a 25-μm-thick insulative film layer was formed on the resulting metal conductor layer in the same manner as in Example 1. It was possible to properly handle the resulting laminate without wrinkling and folding.

Then, the aluminum foil serving as the heat resistant base was peeled off from the laminate as in Example 2. At this time, the peeling was easily achieved. Thus, a 28-μm thick substrate (one-sided plate) for a flexible printed wiring board was produced, which included the metal conductor layer composed essentially of copper and the insulative film layer of the non-thermoplastic polyimide resin.

### Example 11

An 18-μm thick electrodeposited copper foil (F2 foil available from Furukawa Circuit Foil Co., Ltd.) was used as a heat resistant base, and a 0.4-μm thick copper layer was formed as a metal layer (I) on a shiny surface of the foil by sputtering.

In turn, a 2.6-μm thick copper layer was formed as a metal layer (II) on the sputtered copper layer by electrolytic copper plating. Thus, a metal conductor layer of copper having a total thickness of 3.0 μm was formed. Further, a 25-μm thick insulative film layer was formed on the metal conductor layer in the same manner as in Example 1. It was possible to properly handle the resulting laminate without wrinkling and folding.

Then, the electrodeposited copper foil serving as the heat resistant base was peeled off from the laminate as in Example 2. At this time, the peeling was easily achieved. As a result, a 28-μm thick substrate (one-sided plate) for a flexible printed wiring board was produced, which included the metal conductor layer of copper and the insulative film layer of the non-thermoplastic polyimide resin.

### Example 12

An 18-μm thick rolled copper foil (RCF-T5B foil available from Fukuda Metal Foil & Powder Co., Ltd.) was used as a heat resistant base, and a 0.4-μm thick copper layer was formed as a metal layer (I) on a shiny surface of the foil by sputtering.

In turn, a 2.6-μm thick copper layer was formed as a metal layer (II) on the sputtered copper layer by electrolytic copper plating. Thus, a metal conductor layer of copper having a total thickness of 3.0 μm was formed. Further, a 25-μm thick insulative film layer was formed on the metal conductor layer in the same manner as in Example 1. It was possible to properly handle the resulting laminate without wrinkling and folding.

Then, the rolled copper foil serving as the heat resistant base was peeled off from the laminate as in Example 2. At this time, the peeling was easily achieved. As a result, a 28-μm thick substrate (one-sided plate) for a flexible printed wiring board was produced, which included the metal conductor layer of copper and the insulative film layer of the non-thermoplastic polyimide resin.

The properties of the laminates and the flexible printed wiring board substrates of Examples 1 to 6 and 9 to 12 are shown in Table 1.

TABLE 1

| | | | | | | | | | Comparative |
|---|---|---|---|---|---|---|---|---|---|
| | Example | | | | | | | | Example |
| | 1, 2 | 3, 4 | 5 | 6 | 9 | 10 | 11 | 12 | 1 |
| Heat resistant | PI film-50 | PI film-50 | PI film-50 | PI film-50 | Al foil-50/ | Al foil-50 | Electro- | Rolled Cu | PET film-50/ |
| base - thickness | | | | | PI-1 | | Deposited | foil-18 | Silicone |
| (μm) | | | | | | | Cu foil-18 | | release layer |

Structure of metal conductor layer (formation method, type - thickness(μm)

| | | | | | | | | | |
|---|---|---|---|---|---|---|---|---|---|
| Metal layer (I) | Sputtering | Sputtering | Sputtering | Sputtering | Sputtering | Sputtering | Sputtering | Sputtering | Sputtering |
| | Cu-0.2 | Cu-0.2 | Cu-1.0 | Cu-0.2 | Cu-0.2 | Cu-0.4 | Cu-0.4 | Cu-0.4 | Cu-0.2 |
| Metal layer (II) | Plating | Plating | — | Plating | Plating | Plating | Plating | Plating | Plating |
| | Cu-1.8 | Cu-1.8 | | Cu-4.8 | Cu-1.8 | Cu-2.6 | Cu-2.6 | Cu-2.6 | Cu-1.8 |
| | — | Vapor | — | — | Vapor | Vapor | — | — | — |
| | | deposition | | | deposition | deposition | | | |
| | | Ni/Cr-0.15 | | | Ni/Cr-0.15 | Ni/Cr-0.15 | | | |
| Total thickness | 2.0 | 2.15 | 1.0 | 5.0 | 2.15 | 3.15 | 3.0 | 3.0 | 2.0 |
| (μm) | | | | | | | | | |
| Appearance of | Good | Good | Good | Good | Good | Good | Good | Good | Bad |
| laminate | | | | | | | | | |
| Peelability | Good | Good | Good | Good | Good | Good | Good | Good | — |
| Peel strength | 0.08 | 0.24 | 0.06 | 0.18 | 0.21 | 0.16 | 0.25 | 0.19 | — |
| (kN/m) | | | | | | | | | |
| Solder heat | No change | No change | No change | No change | No change | No change | No change | No change | — |
| resistance test | in | in | in | in | in | in | in | in | |
| | appearance | appearance | appearance | appearance | appearance | appearance | appearance | appearance | |

As shown in Table 1, none of Examples suffered from defective appearance in the hot press. Further, Examples were excellent in peelability when the heat resistant bases were peeled off, and were excellent in solder heat resistance. Thus, the laminates and the flexible printed wiring board substrates of Examples of the present invention each had excellent properties.

### Comparative Example 1

A 50-μm thick polyester film (EMBLET available from Unitika, Ltd., having a glass transition temperature of 72° C., and hereinafter referred to simply as “PET film”) having a release layer formed by applying a silicone release agent (SEPA-COAT available from Shin-Etsu Chemical Co., Ltd.) thereon and drying the release agent was used as a base having poorer heat resistance. A 0.2-μm thick copper layer was formed as a metal layer (I) on a surface of the release layer of the base by sputtering. In turn, a 1.8-μm thick copper layer was formed as a metal layer (II) on the sputtered copper layer by electrolytic copper plating. Thus, a metal conductor layer of copper having a total thickness of 2.0 μm was formed. Subsequently, the polyimide precursor solution was uniformly applied on the metal conductor layer by a comma coater as in Example 1, and then dried at 140° C. until the viscosity of the solution was lost. Further, the polyimide precursor was heated to 350° C. in a nitrogen gas atmosphere in an oven to be thereby cured into a polyimide. The resulting laminate suffered from considerable wrinkling and deformation, and the base was mostly separated from the metal conductor layer of the laminate. Therefore, it was impossible to thereafter handle the laminate

The properties of the laminate of Comparative Example 1 are shown in Table 1.

1: A laminate comprising:
a heat resistant base; and
a metal conductor layer provided on at least one surface of the heat resistant base;
wherein the heat resistant base is peelable from the metal conductor layer.

2: A laminate as set forth in claim 1, wherein no release layer is present between the heat resistant base and the metal conductor layer.

3: A laminate as set forth in claim 1, having a peel strength of not greater than 0.5 kN/m at an interface between the heat resistant base and the metal conductor layer.

4: A laminate as set forth in claim 1, wherein the metal conductor layer has a thickness not less than 0.1 μm and not greater than 9 μm.

5: A laminate as set forth in claim 1, wherein the heat resistant base is a metal foil.

6: A laminate as set forth in claim 1, wherein the heat resistant base is a film of a non-thermoplastic polyimide resin.

7: A laminate as set forth in claim 1, wherein the metal conductor layer comprises at least one of a vapor deposition metal layer and a plating metal layer.

8: A laminate as set forth in claim 1, wherein the metal conductor layer comprises a metal layer (I) formed in an interface with the heat resistant base by vapor deposition, and at least one metal layer (II) formed on the metal layer (I) by one of vapor deposition and electroplating.

9: A laminate as set forth in claim 8, wherein the metal layer (I) has a thickness of 0.01 to 2.

10: A laminate as set forth in claim 8, wherein the metal layer (I) and the metal layer (II) are each composed of a metal selected from the group consisting of copper, nickel, zinc, tin, chromium, cobalt, titanium, platinum, gold and silver, and alloys of any of these metals.

11: A laminate as set forth in claim 1, further comprising at least one insulative film layer of a non-thermoplastic polyimide resin provided on the metal conductor layer.

12: A laminate comprising a pair of laminates as recited in claim 11, the laminates being combined together with their insulative film layers being bonded to each other with an adhesive.

13: A laminate produced by peeling off a heat resistant base from a laminate as recited in claim 11.

14: A flexible printed wiring board substrate comprising a laminate as recited in claim 13.

15: An electronic component comprising a laminate as recited in claim 13 to define one of a capacitor electrode component, a capacitor and a secondary battery.

16: A method of producing a laminate as recited in claim 1, comprising the step of forming a metal conductor layer on at least one surface of a heat resistant base by at least one of vapor deposition and plating.

17: A method of producing a laminate as recited in claim 1, comprising the steps of:
forming a metal layer (I) by depositing a metal on at least one surface of a heat resistant base by vapor deposition; and
forming a metal layer (II) by depositing a metal on the metal layer (I) by one of vapor deposition and electroplating.
